(19) United States
(12) Patent Application Publication
(10) Pub. No.: US 2014/0043430 A1
(43) Pub. Date: Feb. 13, 2014

(54) APPARATUS AND METHOD FOR PROVIDING GROUP COMMUNICATION SERVICE

(71) Applicant: ELECTRONICS AND TELECOMMUNICATIONS RESEARCH INSTITUTE, Daejeon (KR)

(72) Inventors: Mi-Sun YU, Daejeon (KR); Ji-Young KWAK, Incheon (KR); Seon-Tae KIM, Daejeon (KR); Jun-Keun SONG, Daejeon (KR); Woo-Suk CHA, Haenam (KR)

(73) Assignee: ELECTRONICS AND TELECOMMUNICATIONS RESEARCH INSTITUTE, Daejeon (KR)

(21) Appl. No.: 13/953,035

(22) Filed: Jul. 29, 2013

(30) Foreign Application Priority Data
Aug. 8, 2012 (KR) 10-2012-0086963

(51) Int. Cl. H04N 7/15

(52) U.S. Cl. CPC H04N 7/15
USPC 348/14.08

(57) ABSTRACT

The present invention relates to an apparatus and method for providing and controlling multimedia group communication service based on a mesh network. The apparatus for providing a group communication service includes a group communication management module, and an audio and video management module. The group communication management module controls and manages group communication between a plurality of user terminals connected to an internal network independent of an external network. The audio and video management module receives audio and video data for group communication from the microphone and camera of each of the user terminals and manages the audio and video data. The group communication management module includes a packet management unit configured to generate packets that are used to control the group communication, a terminal search unit, and a group communication control unit.

### CROSS REFERENCE TO RELATED APPLICATION

This application claims the benefit of Korean Patent Application No. 10-2012-0086963, filed on Aug. 8, 2012, which is hereby incorporated by reference in its entirety into this application.

### BACKGROUND OF THE INVENTION

1. Technical Field

The present invention relates generally to an apparatus and method for providing a group communication service and, more particularly, to an apparatus and method for providing and controlling a multimedia group communication service based on a mesh network.

2. Description of the Related Art

In general, a mobile communication system is configured so that one-to-one voice calls can be made between mobile communication terminals or between a wired telephone and a mobile communication terminal through a communication path. In order to mitigate exclusiveness attributable to the one-to-one voice call and provide additional functions to a voice call, group communication service in which a plurality of mobile communication terminals belonging to a group can perform a voice call at the same time has been recently developed and put into use.

In this group communication service of a mobile communication system, hundreds of subscribers can participate in group communication at the same time, subscriber terminals deployed in different areas can smoothly perform multi-communication over a nationwide network, and the group communication function can be employed for useful purposes, such as a multilateral conference.

The group communication service of a mobile communication system is problematic in that it does not support multimedia group communication between mobile terminals over a local network that is not connected to the Internet because a communication link is set up based on the Internet, necessitating a server, as disclosed in Korean Patent Application Publication No. 2007-0075841 (published on Jul. 24, 2007) entitled “Group Communication Service Method and System.”

### SUMMARY OF THE INVENTION

Accordingly, the present invention has been made keeping in mind the above problems occurring in the prior art, and an object of the present invention is to provide an apparatus and method for providing a group communication service, which can provide an architecture for supporting multimedia group communication based on a local mesh network that is not connected to the Internet.

In accordance with an aspect of the present invention, there is provided an apparatus for providing a group communication service, including a group communication management module configured to control and manage group communication between a plurality of user terminals connected to an internal network independent of an external network; and an audio and video management module configured to receive audio and video data for group communication from a microphone and camera of each of the user terminals and to manage the audio and video data; wherein the group communication management module includes a packet management unit configured to generate packets that are used to control the group communication; a terminal search unit configured to send a group communication connection packet of the generated packets to a plurality of adjacent user terminals over the internal network and to search for user terminals capable of participating in the group communication based on response packets received from the plurality of adjacent user terminals; and a group communication control unit configured to control the group communication between user terminals belonging to a communication group by sending a communication group generation packet of the generated packets to the retrieved user terminals participating in the group communication in order to form the communication group and also sending a group communication control packet of the generated packets to the retrieved user terminals participating in the group communication in order to change or switch the communication group.

The packet management unit may generate a packet adapted to be used to search for adjacent user terminals to connect the group communication, a packet adapted to provide information about a group communication participation request, a packet adapted to provide information about a group communication participation response, a packet adapted to provide information about a list of members of the communication group now participating in the group communication, and a packet adapted to provide information about termination of the group communication, as the packets used to control the group communication between the plurality of user terminals.

The packet adapted to be used to search for adjacent user terminals to connect the group communication may includes common header content, a number of communication groups participating in the group communication, IDs of the communication groups participating in the group communication, and information about a communication state; the packet adapted to provide information about a group communication participation request may include information about common header content; and the packet adapted to provide information about a group communication participation response may include common header content and information about whether or not a user terminal will participate in the group communication.

The packet adapted to provide information about a list of members of the communication group now participating in the group communication may include common header content and information about the list of members participating in the group communication; and the packet adapted to provide information about a termination of the group communication may include common header content.

If a new communication group that will participate in the group communication is generated, the group communication control unit of a user terminal which has received group communication participation request packets from adjacent user terminals may perform control so that the new communication group is generated by sending a packet, including information about whether or not the adjacent user terminals will participate in the group communication, to the adjacent user terminals over the internal network.

If a request to generate a new communication group is received in a state in which the group communication control unit of a user terminal which has received group communication participation request packets from new adjacent user terminals participates in the group communication, the group communication control unit may perform control so that the communication group is changed or switched by sending a packet, including information about whether or not the new adjacent user terminals will participate in the new communication group, to the new adjacent user terminals over the internal network.

If a request to add a new member to the communication group participating in the group communication is received, the group communication control unit of a user terminal which has received group communication participation request packets and a packet adapted to provide information about a list of members of the communication group now participating in the group communication from new adjacent user terminals may perform control so that the new member is added to the communication group by sending a packet, including information about whether or not the new member will be added to the communication group, to the new adjacent user terminals over the internal network.

If a request to terminate the group communication is received, the group communication control unit of a user terminal which has received packets adapted to provide information about termination of the group communication from the adjacent user terminals may perform control so that the group communication is terminated by sending a packet, including group communication termination notification, to the adjacent user terminals over the internal network.

The apparatus may further include an audio and video management module configured to receive and manage the audio and video data for the group communication from a microphone and a camera.

The audio and video management module may include a capturing unit configured to capture audio and video data from the microphone and the camera; an encoding unit configured to encode the captured audio and video data; a decoding unit configured to decode the encoded audio and video data; and a transmission/reception unit configured to transmit and receive the encoded audio and video data.

The apparatus may further include an audio and video output module configured to output the audio and video data for the group communication, received from the audio and video management module, via a speaker and a screen.

In accordance with another aspect of the present invention, there is provided a method of providing a group communication service, including generating, by a group communication management module, packets that are used to control group communication between a plurality of user terminals; sending, by the group communication management module, a group communication connection packet of the generated packets to a plurality of adjacent user terminals connected to an internal network, and searching, by the group communication management module, for user terminals capable of participating in the group communication based on response packets received from the plurality of adjacent user terminals; and controlling, by the group communication management module, the group communication between user terminals belonging to a communication group by sending a communication group generation packet of the generated packets to the retrieved user terminals participating in the group communication in order to form the communication group and also sending a group communication control packet of the generated packets to the retrieved user terminals participating in the group communication in order to change or switch the communication group.

Controlling the group communication between user terminals belonging to a communication group may include, if a new communication group that will participate in the group communication is generated, performing, by the group communication control unit of a user terminal which has received group communication participation request packets from adjacent user terminals, control so that the new communication group is generated by sending a packet, including information about whether or not the adjacent user terminals will participate in the group communication, to the adjacent user terminals over the internal network.

Controlling the group communication between user terminals belonging to a communication group may include, if a request to generate a new communication group is received in a state in which the group communication control unit of a user terminal which has received group communication participation request packets from new adjacent user terminals participates in the group communication, performing, by the group communication control unit, control so that the communication group is changed or switched by sending a packet, including information about whether or not the new adjacent user terminals will participate in the new communication group, to the new adjacent user terminals over the internal network.

Controlling the group communication between user terminals belonging to a communication group may include, if a request to add a new member to the communication group participating in the group communication is received, performing, by the group communication control unit of a user terminal which has received group communication participation request packets and a member list packet for the communication group now participating in the group communication from new adjacent user terminals, control so that the new member is added to the communication group by sending a packet, including information about whether or not the new member will be added to the communication group, to the new adjacent user terminals over the internal network.

Controlling the group communication between user terminals belonging to a communication group may includes, if a request to terminate the group communication is received, performing, by the group communication control unit of a user terminal which has received group communication termination packets from adjacent user terminals, control so that the group communication is terminated by sending a packet, including group communication termination notification, to the adjacent user terminals over the internal network.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a system for providing an apparatus and method for providing a group communication service according to an embodiment of the present invention;

FIG. 2 is a diagram showing the configuration of the apparatus for providing a group communication service according to an embodiment of the present invention;

FIG. 3 shows the detailed configuration of a group communication management module included in the apparatus for providing a group communication service according to an embodiment of the present invention;

FIG. 4 shows the detailed configuration of an audio and video management module included in the apparatus for providing a group communication service according to an embodiment of the present invention;

FIG. 5 is a diagram showing the format of a G_HELLO packet generated by the apparatus for providing a group communication service according to an embodiment of the present invention;

FIG. 6 is a flowchart illustrating the method of providing a group communication service according to an embodiment of the present invention;

FIG. 7 is a diagram showing a method of generating and terminating a communication group included in the method of providing a group communication service according to an embodiment of the present invention;

FIG. 8 is a flowchart illustrating a method of processing the reception of multiple communication group participation requests included in the method of providing a group communication service according to an embodiment of the present invention; and

FIG. 9 is a flowchart illustrating a method of processing the transmission of multiple communication group participation requests included in the method of providing a group communication service according to an embodiment of the present invention.

### DESCRIPTION OF THE PREFERRED EMBODIMENTS

Hereinafter, some embodiments of the present invention will be described in detail with reference to the accompanying drawings in order to enable those skilled in the art to easily practice the present invention. It is to be noted that in the assignment of reference numerals to elements in the drawings, the same reference numerals denote the same elements throughout the drawings even in cases where the elements are shown in different drawings. Furthermore, in the description of the present invention, detailed descriptions of the known functions and configurations will be omitted if they are deemed to make the gist of the present invention unnecessarily vague.

An apparatus and method for providing a group communication service according to embodiments of the present invention are described in detail below with reference to the accompanying drawings.

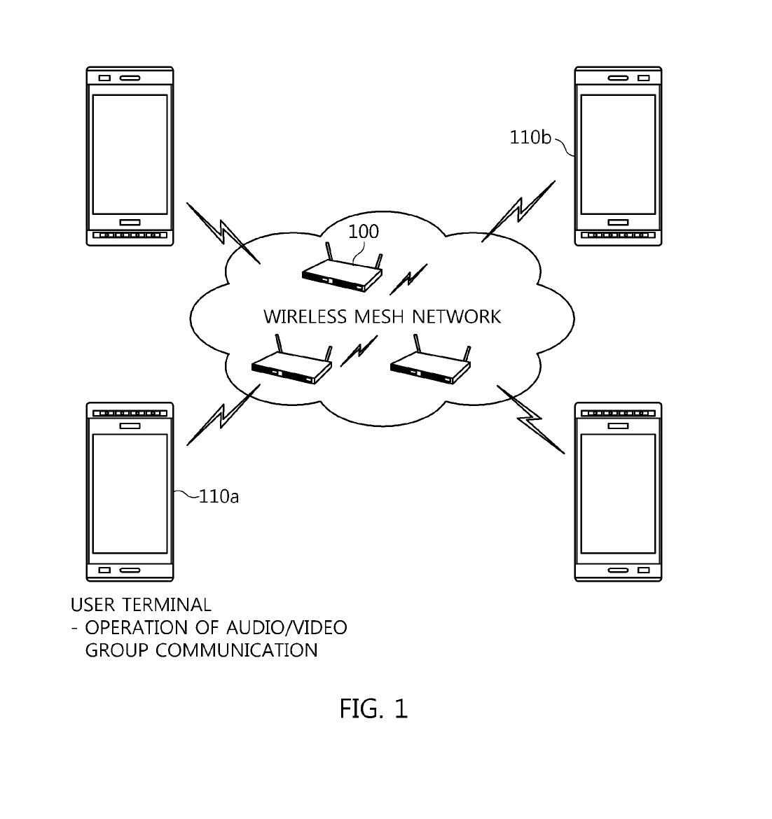

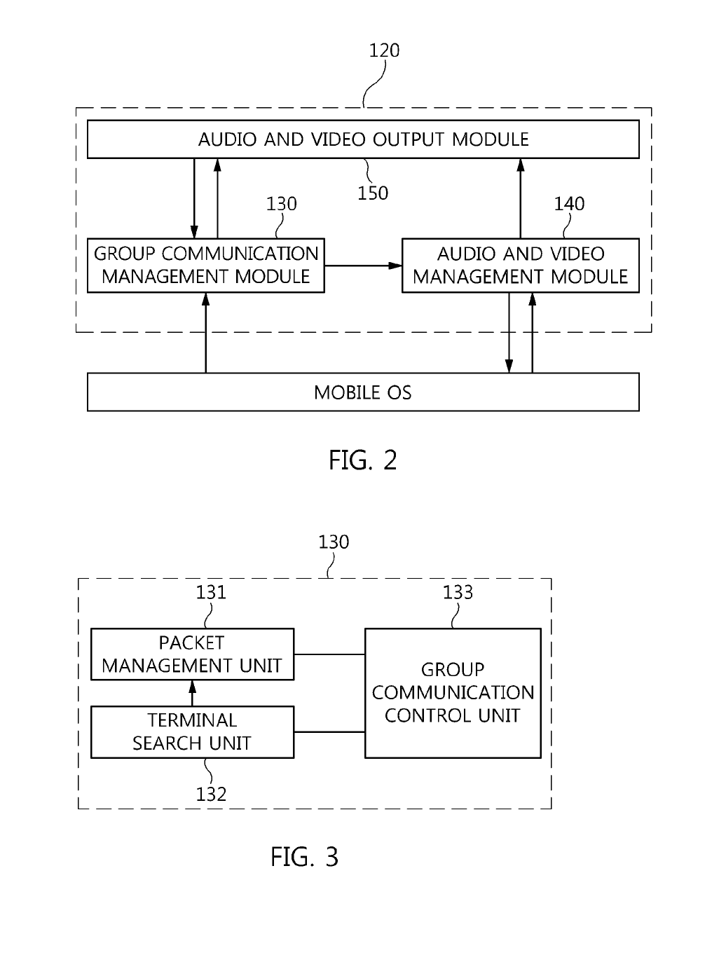

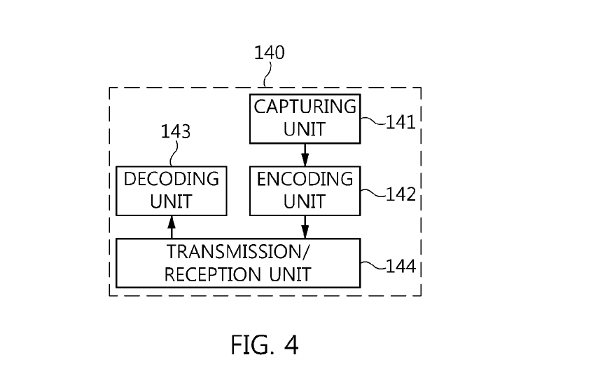

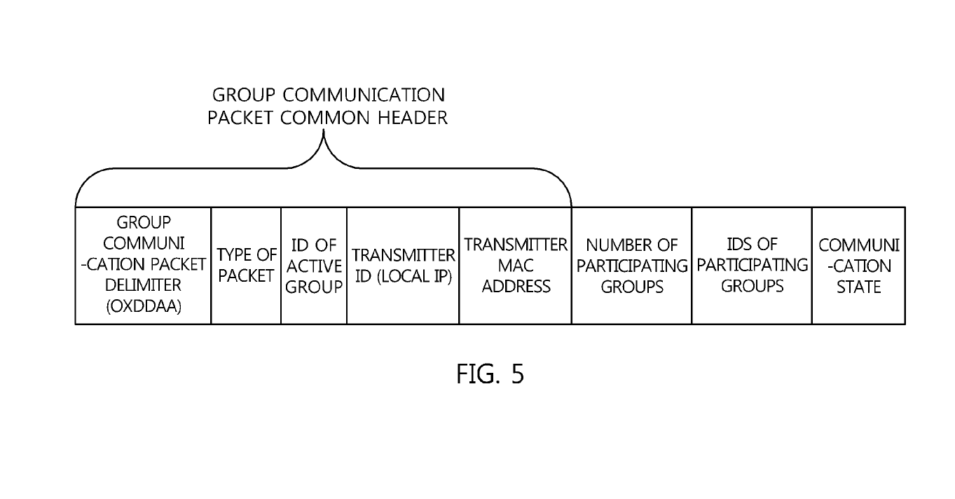

FIG. 1 is a diagram showing the configuration of a system for providing an apparatus and method for providing a group communication service according to an embodiment of the present invention, FIG. 2 is a diagram showing the configuration of the apparatus for providing a group communication service according to an embodiment of the present invention, FIG. 3 shows the detailed configuration of a group communication management module included in the apparatus for providing a group communication service according to an embodiment of the present invention, FIG. 4 shows the detailed configuration of an audio and video management module 140 included in the apparatus for providing a group communication service according to an embodiment of the present invention, and FIG. 5 is a diagram showing the format of a G_HELLO packet generated by the apparatus for providing a group communication service and provided for searching for adjacent user terminals according to an embodiment of the present invention.

Referring to FIGS. 1 to 4, the apparatus for providing a group communication service according to the present invention includes a plurality of relays 100 configured to operate in conjunction with one or more Access Points (APs) and a user terminal 110a equipped with a group communication management module 130 configured to provide group communication service so that group communication with user terminals 110b adjacent to the user terminal 110a can be performed through the plurality of relays 100 based on mobile operating systems, such as Android and iOS, over a mesh network, that is, an independent internal network that is not connected to an external network.

The plurality of relays 100 operates in conjunction with one or more APs based on the mesh network. Here, the mesh network is a communication network including radio nodes that are systemized in a mesh topology. The mesh network basically includes mesh clients, the relays 100, and gateways. The mesh client is commonly a laptop computer, a mobile phone, or other wireless devices, whereas the relay 100 performs communication from or to a gateway although the gateway does not need to be connected to the Internet. Furthermore, each of the relays 100 includes an AP for assigning a local IP for communication when the user terminal 110a and a plurality of the adjacent user terminals 110b are connected to the plurality of relays 100. Here, when the user terminal 110a equipped with the group communication management module 130 according to the present invention searches for the relay 100 forming the mesh network and connects to the retrieved relay 100 in such a way as to access an Internet AP, the user terminal 110a can perform group communication with adjacent user terminals 110b connected to the mesh network.

Each of the user terminals 110a and 110b includes the group communication management module 130 configured to provide group communication service, an audio and video management module 140 configured to receive and manage audio and video data for group communication from a microphone and a camera contained in the user terminal, and an audio and video output module 150 configured to output the audio and video data for group communication, received from the audio and video management module 140, through a speaker and a screen contained in the user terminal.

The group communication management module 130 functions to maintain group communication and manage the state of group communication in response to an event generated from the user terminal 110a received through the audio and video output module 150, and packets related to the generation and termination of a group and received from adjacent user terminals 110b. Furthermore, the group communication management module 130 continues to search for adjacent user terminals 110b capable of group communication that are located near the user terminal. Furthermore, the group communication management module 130 controls the generation of a communication group, the change or switching of a communication group, and the termination of group communication.

To this end, the group communication management module 130 includes a packet management unit 131, a terminal search unit 132, and a group communication control unit 133.

The packet management unit 131 generates and gathers packets that are used when controlling group communication between a plurality of user terminals connected to an internal network that is not connected to an external network. The packet management unit 131 generates packets related to the connection of group communication, the generation of a communication group, the change or switching of a communication group, and the termination of group communication that are used when group communication is performed. The packet management unit 131 generates a packet (e.g., a G_HELLO packet) adapted to be used to search for adjacent user terminals for the connection of group communication, a packet (e.g., a G_JOIN_REQ packet) adapted to provide information about a group communication participation request, a packet (e.g., a G_JOIN_RES packet) adapted to provide information about a group communication participation response, a packet (e.g., a G_MEM_INFO packet) adapted to provide information about a list of the members of a communication group now participating in group communication, and a packet (e.g., a G_TERM_NOTIFY packet) adapted to provide information about the termination of group communication.

The G_HELLO packet that is used to search for adjacent user terminals includes common header content, the number of communication groups participating in group communication, the IDs of the communication groups participating in the group communication, and information about a communication state. The G_JOIN_REQ packet adapted to provide information about a group communication participation request includes information about common header content. The G_JOIN_RES packet adapted to provide information about a group communication participation response includes common header content and information about whether or not a user terminal participates in group communication. The G_MEM_INFO packet adapted to provide information about a list of the member of a communication group includes common header content and information about a list of members participating in group communication. The G_TERM_NOTIFY packet adapted to provide information about the termination of group communication includes common header content.

The terminal search unit 132 searches for user terminals 110b adjacent to the user terminal 110a. That is, the terminal search unit 132 sends a group communication connection packet of the generated packets to the plurality of adjacent user terminals 110b connected to an internal network, and searches for user terminals capable of participating in group communication based on response packets received from a plurality of adjacent user terminals. The terminal search unit 132 periodically broadcasts the G_HELLO packet used to search for adjacent user terminals over the mesh network in order to search for adjacent user terminals 110b capable of participating in group communication and manage the state of the members of group communication. As shown in FIG. 5, the format of the G_HELLO packet that is used to search for adjacent user terminals is defined by a common header included in all group communication packets in common and fields, such as the number and IDs of groups participating in group communication and a communication state that are added to the common header. Here, the common header includes fields, such as a group communication packet delimiter, the type of packet, an active group ID, a transmitter ID, and a transmitter MAC address.

Each of the fields will be described in detail below. The group communication packet delimiter is an indicator adapted to distinguish packets that are used when group communication is performed over the mesh network. The type of packet is a delimiter to identify the type of packet. The active group ID is an ID value of a group in an active state, which belongs to communication groups in which the user terminal 110b sending the G_HELLO packet participates, and is set to 0 if the user terminal 110b sending the G_HELLO packet does not belong to any group. The transmitter ID is an ID value of a user terminal 110b that sends the G_HELLO packet and is set to a local IP value assigned to the user terminal 110b when accessing an AP. If the accessed AP is changed, the transmitter ID may be changed. The transmitter MAC address is a MAC address value of the user terminal 110b that sends the G_HELLO packet and is not always changed. Since the IP value may be changed when an AP is changed, the MAC address value is used as a delimiter for identifying the user terminal 110b that sends the G_HELLO packet. After receiving the G_HELLO packet, the user terminal 110b may check that a user terminal 110b is what user terminal by reading the MAC address field, read the group ID and group communication state fields, and update information about members based on the group ID and group communication state fields. The number of groups participating in group communication indicates the number of groups in which the user terminal 110b sending the G_HELLO packet now participates in group communication. The IDs of groups participating in group communication indicates are ID values of all groups in which the user terminal 110b sending the G_HELLO packet now participates in group communication. The communication state indicates a communication state in which the user terminal 110b sending the G_HELLO packet is present. The communication state is set to idle mode or busy mode, and idle mode and busy mode may be set to values 0 and 1.

As described above, the terminal search unit 132 generates and maintains a list of adjacent user terminals 110b capable of group communication and the AC address, local IP, number and IDs of participating groups, and active group ID of the adjacent user terminals 110b based on the G_HELLO packet used to search for adjacent user terminals and continues to update the fields. Furthermore, the terminal search unit 132 makes the user terminal 110a maintain the same information (i.e., an MAC address, a local IP, the number and IDs of participating groups, and an active group ID) as that of adjacent user terminals in order to externally send the G_HELLO packet used to search for adjacent user terminals.

The group communication control unit 133 controls the generation of a communication group participating in group communication, the change or switching of a communication group, and the termination of group communication. That is, the group communication control unit 133 controls group communication between user terminals belonging to a communication group by sending a communication group generation packet of the generated packets to the retrieved user terminals participating in the group communication in order to form the communication group and sending a group communication control packet of the generated packets to the retrieved user terminals participating in the group communication in order to change or switch the communication group. Here, the group communication control unit 133 forms the communication group based on packets related to information about a group communication participation request and response that are generated by the packet management unit 131. Furthermore, the group communication control unit 133 changes or switches the communication group based on packets related to information about a group communication participation request and response that are generated by the packet management unit 131. Furthermore, the group communication control unit 133 terminates the group communication based on packets related to information about a list of the members of the user terminals 110b now participating in the group communication and information about the termination of the group communication of the user terminal 110a that are generated by the packet management unit 131. This is described in detail later in connection with a method of providing a group communication service.

The audio and video management module 140 receives audio and video for group communication from the microphone and the camera of the user terminal 110a and manages the audio and video.

To this end, the audio and video management module 140 includes a capturing unit 141, an encoding unit 142, a decoding unit 143, and a transmission/reception unit 144.

The capturing unit 141 periodically captures audio and video data from the microphone and the camera and stores the captured audio and video data in a first buffer. The encoding unit 142 reads the captured audio and video data from the first buffer, encodes the read audio and video data, and stores the encoded audio and video data in a second buffer. The decoding unit 143 generates and deletes a decoder for decoding audio and video data captured when a communication group is formed and terminated. Furthermore, the decoding unit 143 generates a decoder for decoding the audio and video data of a member when adding the member to a communication group or reads encoded audio and video data, received from several members, from a third buffer, decodes the read audio and video data, and sends the decoded audio and video data to the audio and video output module 150. When a communication group is formed, the transmission/reception unit 144 manages a session for transmitting and receiving audio and video data to and from other communication group members. The transmission/reception unit 144 reads encoded audio and video data from the second buffer and sends the read audio and video data to a destination over the mesh network. Furthermore, the transmission/reception unit 144 receives encoded audio and video data over the mesh network and stores the received audio and video data in the third buffer along with information about the address of a user terminal 110b that sends the audio and video data.

The audio and video output module 150 receives audio and video data for group communication from the audio and video management module 140 and outputs the received audio and video data to a speaker and a screen. That is, the audio and video output module 150 outputs the audio and video data of the members of a communication group, received from the decoding unit 143, to the speaker and the screen, receives events, such as the participation and termination of group communication and a switching request between audio and video data, from user terminals, and sends the received events to the group communication management module 130.

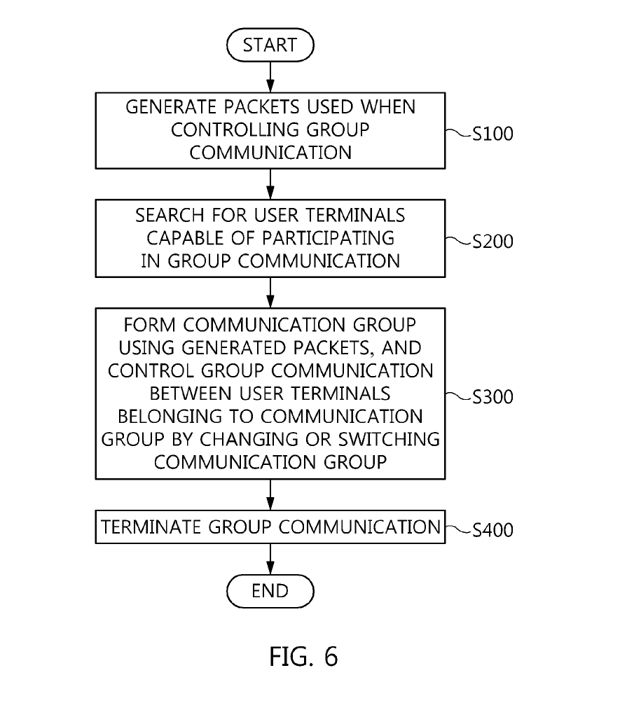

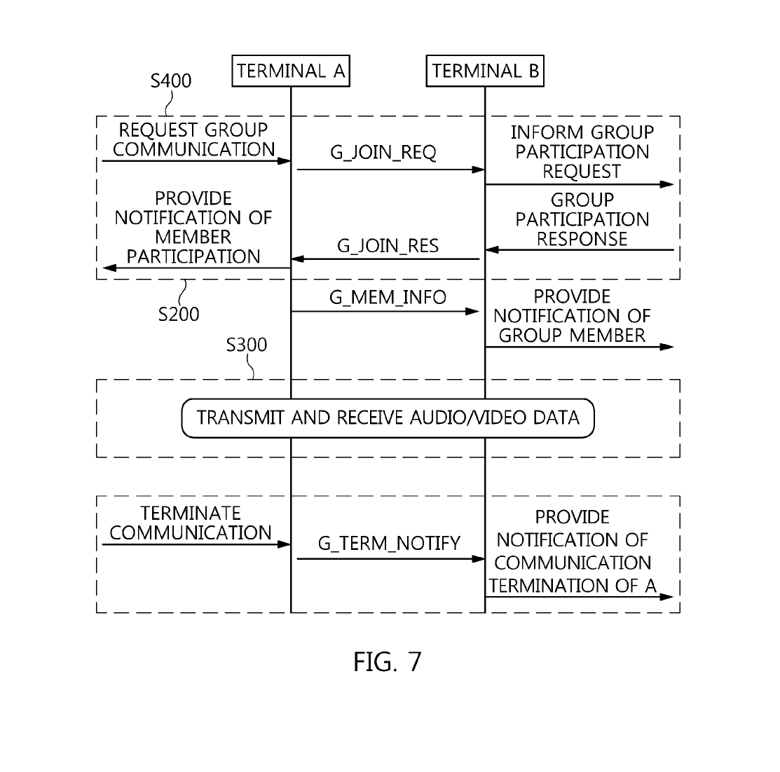

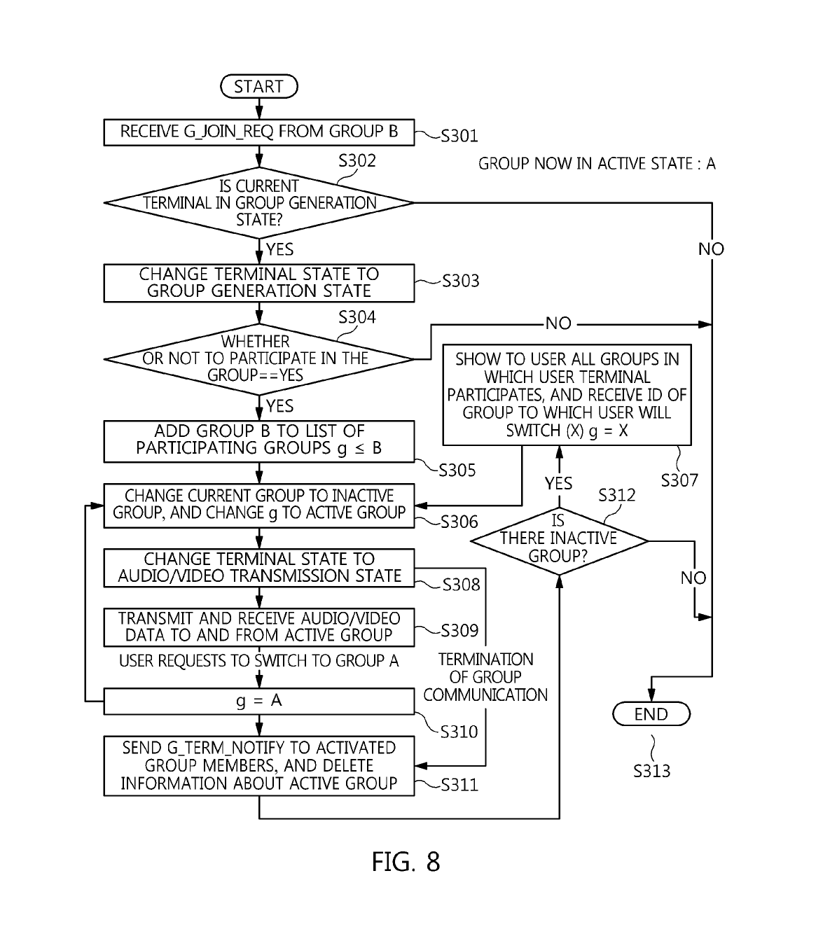

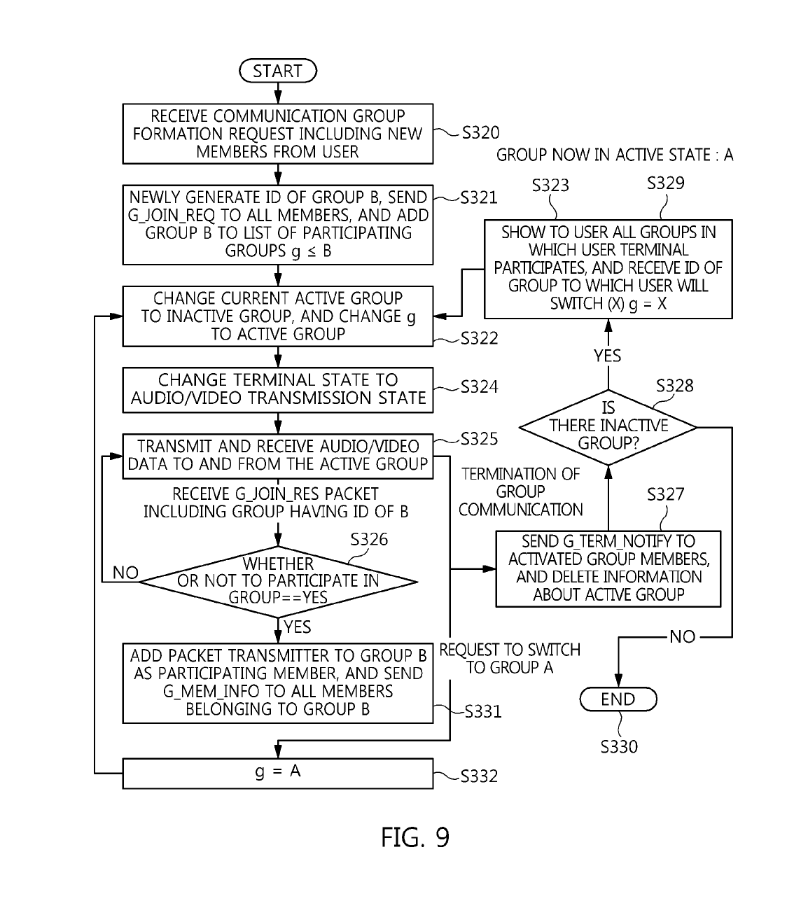

FIG. 6 is a flowchart illustrating a method of providing a group communication service according to an embodiment of the present invention, FIG. 7 is a diagram showing a method of generating and terminating a communication group included in the method of providing a group communication service according to an embodiment of the present invention, FIG. 8 is a flowchart illustrating a method of processing the reception of multiple communication group participation requests included in the method of providing a group communication service according to an embodiment of the present invention, and FIG. 9 is a flowchart illustrating a method of processing the transmission of multiple communication group participation requests included in the method of providing a group communication service according to an embodiment of the present invention.

Referring to FIGS. 6 and 7, in the method of providing a group communication service according to the present invention, the group communication management module 130 that enables group communication between the plurality of user terminals 110a and 110b connected to an internal network that is not connected to an external network provides a group communication service via the user terminal 110a, and first generates packets that are used upon controlling the group communication between the plurality of user terminals 110a and 110b at step S100.

The group communication management module 130 sends a group communication connection packet of the generated packets to the plurality of adjacent user terminals 110b connected to the internal network and searches for user terminals 110a and 110b capable of participating in group communication based on response packets received from the plurality of adjacent user terminals 110b at step S200. When searching for the adjacent user terminals 110b, the group communication management module 130 may manage the states of the user terminal 110a and the adjacent user terminals 110b based on the G_HELLO packets related to state information provided to search for adjacent user terminals.

Thereafter, the group communication management module 130 controls the group communication between the user terminals belonging to the communication group by sending the communication group generation packet of the generated packets to the retrieved user terminals 110a and 110b participating in the group communication in order to form the communication group and sending the group communication control packet of the generated packets to the retrieved user terminals 110a and 110b participating in the group communication in order to change or switch the communication group at step S300. When the communication group is formed, group communication is performed through the transmission and reception of audio and video data between the user terminal 110a and the adjacent user terminals 110b that belong to the communication group at step S300. The audio and video management module 140 of the user terminal 110a receives the audio and video data for group communication from a microphone and a camera, and manages the received audio and video data. The audio and video output module 150 of the user terminal 110a outputs the received audio and video data to the speaker and the screen in order to perform the group communication.

If a communication group that will participate in group communication is formed, the user terminal 110a that has received the group communication participation request packet (i.e., the G_JOIN_REQ packet) from adjacent user terminals 110b sends a packet, including information about whether or not the adjacent user terminals 110b will participate in the group communication, to the adjacent user terminals 110b over the mesh network in order to form the communication group.

The operation between the user terminals 110b when the communication group is formed is as follows. The group communication management module 130 of the user terminal 110b that initiates group communication sends the G_JOIN_REQ packet adapted to provide information about a group communication participation request to corresponding members, in response to group communication requests and a list of the members of the user terminals 110b for group communication received through the audio and video output module 150, receives the G_JOIN_RES packet adapted to provide information about a group communication participation response, including information about whether or not the user terminal 110b will participate in the group communication, and informs other modules (e.g., the audio and video management module 140 and the audio and video output module 150) of the information about whether or not the user terminals 110b will participate in the group communication (i.e., information about whether or not the user terminals 110b will become members to the communication group). If the G_JOIN_RES packet adapted to provide information about a group communication participation response is received from each of the user terminals 110b (if there is no response after a lapse of a specific time, it is determined to be the rejection of the group communication participation), the group communication management module 130 sends the G_MEM_INFO packet adapted to provide information about a list of members now participating in the group communication to the members of the group communication. In response to the G_JOIN_RES packet adapted to provide information about a group communication participation response that is received from the group communication management module 130 of the user terminal 110b, the user terminal 110b that has received the group communication request sends a group participation request event through the audio and video output module 150 and sends the G_JOIN_RES packet adapted to provide information about a group communication participation response in response to information about whether or not the user terminal 110b will participate in the communication group. Furthermore, in response to the G_MEM_INFO packet adapted to provide information about a list of members participating in the group communication, the user terminal 110b that has received the group communication request updates information about the members of a communication group corresponding to a group ID that is included in the G_MEM_INFO packet adapted to provide information about a list of members participating in the group communication and information about a communication group in which a user terminal that has sent the G_MEM_INFO packet and informs other members that the information about the group and members has been updated.

If a new communication group is requested to be formed in the state in which a user terminal participates in group communication, the user terminal sends a packet, including information about whether or not adjacent user terminals will participate in the new communication group, to the adjacent user terminals over the mesh network in response to group communication participation request packets received from the adjacent user terminals, so the communication group can be changed or switched.

Here, the changing of a communication group means that a specific user terminal 110b sends captured audio and video data during group communication and changes a group that will display received data on a screen. A communication group that is now selected is called an active group, and only one active group may be present at one point of time. With regard to a request and acceptance for participation in the other communication group while a specific user terminal 110b is participating in one communication group, the generation of a communication group with the other communication group is started after a communication group with one communication group is formed in order to reduce the complexity of a packet processing procedure and prevent the confusion of the user of the user terminal 110b. More particularly, as shown in FIG. 8, when the user terminal 110b receives the G_JOIN_REQ packet related to information about a group communication participation request that includes the ID of the other communication group in the state in which the user terminal 110b is performing group communication at step S301, the group communication management module 130 of the user terminal 110b checks whether or not the user terminal 110b is in a communication group state at step S302. If, as a result of the check, the user terminal 110b does not belong to a communication group, the group communication management module 130 changes the state of the user terminal 110b to a communication group state at step S303. Here, if the group communication management module 130 is performing a procedure for generating a communication group with the other communication group (i.e., if it has not received any response from members after sending the G_JOIN_REQ packet to the members or if it has not sent the G_JOIN_RES packet after receiving the G_JOIN_REQ packet), a group communication participation request is rejected. If the group communication management module 130 is not performing the procedure, information about whether or not the user terminal 110b will participate in the communication group is received at step S304. If the participation is accepted, information about the new communication group is added to a list of communication groups in which the user terminal 110b is now participating at step S305 and an active group is changed to the new communication group at step S306. After the active group has been changed, audio and video data received from other communication groups are disregarded and only audio and video data received from the active group are output to the user terminal 110b at step S307. Furthermore, audio and video data captured from the microphone and the camera of the user terminal 110b is also sent to the active group at steps S308 to S310. Here, audio and video data received from other group members that are not in an active state is deleted at steps S311 to S313. That is, the addition, activation, and changing of a communication group also influence fields (i.e., the ID of an active group and the number and IDs of participating groups) that are related to the G_HELLO packet that is used to search for adjacent user terminals.

Meanwhile, if a user requests to switch to another communication group in the state in which the user is participating in several communication groups, a list of switchable user terminals are showed to the user, the ID of a group to which the user will switch is received, and an active group is changed to the group. Meanwhile, if a group communication termination request is received from a user while audio and video data is transmitted and received and another inactive group is not present, group communication is finally terminated. If several other inactive groups are present, a current active group is terminated, the ID of a communication group to which a user will be changed is received, and the user is switched to the communication group as follows.

If a request to add a new member to a communication group participating in group communication is received, a user terminal that has received a group communication participation request packet from a new adjacent user terminal and a member list packet for the communication group now participating in group communication sends a packet, including information about whether or not the new member will be added, to adjacent user terminals over the mesh network, so the new member is added to the communication group.

Here, as shown in FIG. 9, when the user terminal 110b receives a communication group formation request, including new members, from a user through the G_JOIN_REQ packet related to information about a group communication participation request in the state in which the user terminal 110b is performing group communication at step S320, the group communication management module 130 of the user terminal 110b sends the G_JOIN_REQ packet, related to information about a group communication participation request, to the new members at step S321 and changes a communication group B as an active group at step S322. Since the active group has been changed, audio and video data received from other communication groups except the active group is disregarded and only audio and video data received from the active group is output at steps S323 to S325. Furthermore, audio and video data captured from the microphone and the camera of the user terminal 110b is transmitted to the active group. Here, if the group communication is terminated, the G_TERM_NOTIFY packet related to information about the termination of the group communication is transmitted to the members of the active group at step S327, whether or not an inactive group is present is checked at step S328, and whether or not to terminate the group communication is determined based on the results of the checking. Meanwhile, if a request to switch the communication group is received, the communication group is switched at step S332. That is, the addition of a communication group and the changing of an active group also influence fields (i.e., the ID of an active group and the number and IDs of participating groups) related to the G_HELLO packet that is used to search for adjacent user terminals. When the G_JOIN_REQ packet adapted to provide information about a group communication participation request regarding the communication group B is received from new member already designated by a user, members that accept participation in group communication are added as the member of the communication group B at steps S330 to S331.

Finally, the group communication management module 130 terminates the group communication at step S400. If the group communication management module 130 of a user terminal receives a group communication termination packet from adjacent user terminals, the group communication management module 130 sends a packet including group communication termination notification to the adjacent user terminals over the mesh network, so that group communication is terminated. Here, the group communication management module 130 terminates the group communication using the G_MEM_INFO packet related to information about a list of communication group members participating in the group communication and the G_TERM_NOTIFY packet related to information about the termination of the group communication of the user terminal 110a. The operation between the user terminals 110b when group communication is terminated is as follows. When the group communication management module 130 of the user terminal 110a receives a communication termination request through the audio and video management module 140, a user terminal 110b that provides notification of the termination of group communication broadcasts the G_TERM_NOTIFY packet, related to information about the termination of group communication, to all members belonging to a communication group, and terminates the group communication. When the group communication management module 130 of an adjacent user terminal 110b receives the G_TERM_NOTIFY packet related to information about the termination of group communication, a user terminal 110b that has received the communication termination notification deletes all pieces of information related to the adjacent user terminal 110b that has received the G_TERM_NOTIFY packet, and informs other modules of the termination of the group communication.

As described above, the apparatus and method for providing a group communication service according to the present invention are advantageous in that they can provide group communication including audio and video multimedia through relays based on a mesh network although an additional server is not used.

Furthermore, the present invention is advantageous in that a communication group can be easily changed and switched and the professionalism of providing a group communication service and user convenience can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing a group communication service, comprising:
a group communication management module configured to control and manage group communication between a plurality of user terminals connected to an internal network independent of an external network; and
an audio and video management module configured to receive audio and video data for group communication from a microphone and camera of each of the user terminals and to manage the audio and video data;
wherein the group communication management module includes:
a packet management unit configured to generate packets that are used to control the group communication;
a terminal search unit configured to send a group communication connection packet of the generated packets to a plurality of adjacent user terminals over the internal network and to search for user terminals capable of participating in the group communication based on response packets received from the plurality of adjacent user terminals; and
a group communication control unit configured to control the group communication between user terminals belonging to a communication group by sending a communication group generation packet of the generated packets to the retrieved user terminals participating in the group communication in order to form the communication group and sending a group communication control packet of the generated packets to the retrieved user terminals participating in the group communication in order to change or switch the communication group.

2. The apparatus of claim 1, wherein the packet management unit generates a packet adapted to be used to search for adjacent user terminals to connect the group communication, a packet adapted to provide information about a group communication participation request, a packet adapted to provide information about a group communication participation response, a packet adapted to provide information about a list of members of the communication group now participating in the group communication, and a packet adapted to provide information about termination of the group communication, as the packets used to control the group communication between the plurality of user terminals.

3. The apparatus of claim 2, wherein:
the packet adapted to be used to search for adjacent user terminals to connect the group communication includes common header content, a number of communication groups participating in the group communication, IDs of the communication groups participating in the group communication, and information about a communication state;
the packet adapted to provide information about a group communication participation request includes information about common header content; and
the packet adapted to provide information about a group communication participation response includes common header content and information about whether or not a user terminal will participate in the group communication.

4. The apparatus of claim 2, wherein:
the packet adapted to provide information about a list of members of the communication group now participating in the group communication includes common header content and information about the list of members participating in the group communication; and
the packet adapted to provide information about a termination of the group communication includes common header content.

5. The apparatus of claim 1, wherein if a new communication group that will participate in the group communication is generated, the group communication control unit of a user terminal which has received group communication participation request packets from adjacent user terminals performs control so that the new communication group is generated by sending a packet, including information about whether or not the adjacent user terminals will participate in the group communication, to the adjacent user terminals over the internal network.

6. The apparatus of claim 1, wherein if a request to generate a new communication group is received in a state in which the group communication control unit of a user terminal which has received group communication participation request packets from new adjacent user terminals participates in the group communication, the group communication control unit performs control so that the communication group is changed or switched by sending a packet, including information about whether or not the new adjacent user terminals will participate in the new communication group, to the new adjacent user terminals over the internal network.

7. The apparatus of claim 1, wherein if a request to add a new member to the communication group participating in the group communication is received, the group communication control unit of a user terminal which has received group communication participation request packets and a packet adapted to provide information about a list of members of the communication group now participating in the group communication from new adjacent user terminals performs control so that the new member is added to the communication group by sending a packet, including information about whether or not the new member will be added to the communication group, to the new adjacent user terminals over the internal network.

8. The apparatus of claim 1, wherein if a request to terminate the group communication is received, the group communication control unit of a user terminal which has received packets adapted to provide information about termination of the group communication from the adjacent user terminals performs control so that the group communication is terminated by sending a packet, including group communication termination notification, to the adjacent user terminals over the internal network.

9. The apparatus of claim 1, wherein the audio and video management module includes:
a capturing unit configured to capture audio and video data from the microphone and the camera;
an encoding unit configured to encode the captured audio and video data;
a decoding unit configured to decode the encoded audio and video data; and
a transmission/reception unit configured to transmit and receive the encoded audio and video data.

10. The apparatus of claim 1, further comprising an audio and video output module configured to output the audio and video data for the group communication, received from the audio and video management module, via a speaker and a screen.

11. A method of providing a group communication service, comprising:
generating, by a group communication management module, packets that are used to control group communication between a plurality of user terminals;
sending, by the group communication management module, a group communication connection packet of the generated packets to a plurality of adjacent user terminals connected to an internal network, and searching, by the group communication management module, for user terminals capable of participating in the group communication based on response packets received from the plurality of adjacent user terminals; and
controlling, by the group communication management module, the group communication between user terminals belonging to a communication group by sending a communication group generation packet of the generated packets to the retrieved user terminals participating in the group communication in order to form the communication group and sending a group communication control packet of the generated packets to the retrieved user terminals participating in the group communication in order to change or switch the communication group.

12. The method of claim 11, wherein controlling the group communication between user terminals belonging to a communication group includes, if a new communication group that will participate in the group communication is generated, performing, by the group communication control unit of a user terminal which has received group communication participation request packets from adjacent user terminals, control so that the new communication group is generated by sending a packet, including information about whether or not the adjacent user terminals will participate in the group communication, to the adjacent user terminals over the internal network.

13. The method of claim 11, wherein controlling the group communication between user terminals belonging to a communication group includes, if a request to generate a new communication group is received in a state in which the group communication control unit of a user terminal which has received group communication participation request packets from new adjacent user terminals participates in the group communication, performing, by the group communication control unit, control so that the communication group is changed or switched by sending a packet, including information about whether or not the new adjacent user terminals will participate in the new communication group, to the new adjacent user terminals over the internal network.

14. The method of claim 11, wherein controlling the group communication between user terminals belonging to a communication group includes, if a request to add a new member to the communication group participating in the group communication is received, performing, by the group communication control unit of a user terminal which has received group communication participation request packets and a member list packet for the communication group now participating in the group communication from new adjacent user terminals, control so that the new member is added to the communication group by sending a packet, including information about whether or not the new member will be added to the communication group, to the new adjacent user terminals over the internal network.

15. The method of claim 11, wherein controlling the group communication between user terminals belonging to a communication group includes, if a request to terminate the group communication is received, performing, by the group communication control unit of a user terminal which has received group communication termination packets from adjacent user terminals, control so that the group communication is terminated by sending a packet, including group communication termination notification, to the adjacent user terminals over the internal network.
